(19) United States
(12) Patent Application Publication
(10) Pub. No.: US 2008/0205518 A1
(43) Pub. Date: Aug. 28, 2008

(54) Image Coder for Regions of Texture

(75) Inventors: Piotr Wilinski, Warszawa-Wesola (PL); Stijn De Waele, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,544

(22) PCT Filed: Jul. 12, 2006
(86) PCT No.: PCT/IB2006/052358

§ 371 Date: Jan. 14, 2008

(30) Foreign Application Priority Data
Jul. 15, 2005 (EP) 05106503.5

(51) Int. Cl. H04B 1/66

(52) U.S. Cl. 375/240.08; 375/E07.081

(57) ABSTRACT

An image encoder (20) for compressing an input image comprising at least one of a first region and a second region, and a third region, the image encoder comprising an estimator (21) arranged to estimate a third texture parameter (ρ₃ₑ) from at least one of a first texture parameter (ρ₂₀) of the first region and a second texture parameter (ρ₂₀) of the second region according to a predetermined estimating algorithm (K), a comparator (22) arranged to compare a representation (R₃′) of a generated texture corresponding to the estimated third texture parameter (ρ₃ₑ) with a representation (R₃) of a texture present in the third region of the input image according to a pre-determined matching criterion and to calculate a degree of match value (μₘ); and a data encoder (23) arranged to encode at least one of the first texture parameter and the second texture parameter (ρ₁₀, ρ₂₀) into a compressed data stream ST(ρ₁₀, ρ₂₀, . . . ) and arranged to encode the texture present in the third region of the input image with a codification of the estimating algorithm (K) in the compressed data stream ST(ρ₁₀, ρ₂₀,K) when the degree of match value (μₘ) is within a pre-specified interval.

The invention relates to an image encoder for compressing an image comprising regions of texture into a compressed data stream.

The invention further relates to a method of encoding an image comprising regions of texture into a compressed data stream, an image decoder for decoding a compressed data stream into an image comprising regions of texture, to a method of decoding a compressed data stream into an image comprising regions of texture, to a transmitter for transmitting a compressed data stream of encoded image comprising regions of texture, to a portable device for transmitting a compressed data stream of encoded image, to a receiver for receiving a compressed data stream and decode an image comprising regions of texture, to a compressed encoded image signal, to a method of transmission of compressed encoded image signal and to a computer program product for executing any of the methods mentioned above.

Video information comprising a sequence of images is encoded into a compressed digital data stream for efficient transmission and storage. In recent years, there is a considerable interest in development of better coders and decoders to reduce bandwidth while preserving a high quality of decoded images. Compression of image sequences with regions of textures brings additional challenges such as, higher bandwidth requirements for better quality of reproduction of textures in decoded images.

Images amongst other types of textures can contain stochastic textures. A representation of a stochastic texture may be obtained by finding its most resembling parametric model. Instead of encoding a region of texture by conventional methods, it is advantageous in terms of bit-rate reduction to encode a parametric model of the texture and boundary information of the region, wherever required, into the compressed data stream. The compressed data stream is received at the decoder and the decoded texture parameters for example, statistical parameters of the texture and the boundary information are used to reconstruct the region of texture in the output image. Due to psycho-visual perception of the human eye, such reconstructed textures are not effectively distinguished from the textures as present in the original image.

An embodiment of an image coding system for encoding the parameters representing a texture model into a compressed data stream and decoding the parameters of the texture model and reconstructing the textured regions at the output image is known in prior art for example, “An Encoder-Decoder Texture Replacement Method With Application to Content-Based Movie Coding” by Adrina Dumitras and Barry G. Haskell in Vol. 14, No 6, June 2004 issue of IEEE Transactions on Circuits and Systems.

However, a disadvantage of the prior art is that encoding of a large number of textures still requires considerable amount of data to be encoded, in particular if one wants to encode the textures accurately, even when the parameters representing the texture models are encoded.

It is desirable to provide an image encoder for compressing an image comprising regions of texture in a more efficient manner.

This is achieved in that the image encoder for compressing an image comprising at least one of a first region, a second region and a third region, the image encoder comprises:

an estimator arranged to estimate a third texture parameter from at least one of a first texture parameter of the first region and a second texture parameter of the second region according to a predetermined estimating algorithm;

a comparator arranged to compare a representation of a generated texture corresponding to the estimated third texture parameter with a representation of a texture present in the third region of the input image according to a pre-determined matching criterion and to calculate a degree of match value; and

a data encoder arranged to encode at least one of the first texture parameter and the second texture parameter into a compressed data stream and arranged to encode the texture present in the third region of the input image with a codification of the estimating algorithm in the compressed data stream when the degree of match value is within a pre-specified interval.

The inventor has recognized that textures in images very often have a certain degree of similarity on each other and parameters of one texture can be estimated from the parameters of one or more similar textures. Parameters of textures that can be estimated from parameters of dependent textures need not be encoded and transmitted, thereby saving considerable amount of bandwidth or storage space. A pre-determined estimating algorithm, however is required to be codified and transmitted in the compressed data stream. The estimating algorithm is used by a decoder to estimate the parameters of textures that were not transmitted.

According to the invention, the estimator is arranged to estimate a third texture parameter from at least one of the first texture and the second texture parameter according to a pre-determined estimating algorithm. The estimating algorithm is made available at the data encoder for codification and further transmission or storage.

The comparator is arranged to compare a representation of the third texture generated by the estimated texture parameter and a representation of the third texture available in the image. A representation of the third texture can be in the form of pixels or model parameters or statistical properties derived from the textures and a comparison of textures can be carried out in the respective domains. The degree of match value generated by the comparator is a measure of similarity of the generated texture to the available texture and can be used to decide whether the regenerated texture can be substituted for the available texture.

In the data encoder, if the degree of match value is found to be within a pre-specified interval, the estimating algorithm is encoded into the compressed data stream. Otherwise, the actual parameters of the third texture are encoded in the data stream. The estimating algorithm is advantageously encoded with lesser bit-rate compared to the bit-rate required for encoding the parameters of the third texture. Thus a saving of bit-rate is achieved thereby improving the efficiency of encoding the image with regions of texture.

In addition to the saving of bit-rate, the encoder according to the invention has a number of additional advantages. The degree of match value can be considered as a useful quality measure advantageously used in the encoder to select the regions of texture that can be reconstructed from the estimated parameters to closely resemble the available textures. By setting a desired predefined interval in the data encoder for an acceptable degree of match value, a desired quality of match of the generated texture with the available texture can be obtained. Thus by varying the predefined interval, the number of the regions of textures that can be represented by the estimating algorithm can be varied.

The texture parameters and codification of the estimation criterion can be included as additional data in a compressed data stream and make the scheme compatible with any one of the predefined video compression standards.

In an embodiment of the image encoder according to the invention, the estimator is arranged to apply as the predetermined estimating algorithm a weighted combination of the first texture parameter and the second texture parameter.

Weighted combination enables interpolation or extrapolation of parameters of an estimated texture with varying proportions of parameters of contributing textures. By adjusting the weights, it is possible to effectively arrive at an estimate of the third texture parameter to a predetermined accuracy.

In a further embodiment of the image encoder according to the invention, the estimator is arranged to adaptively select weights for the weighted combination by minimizing the degree of match value.

Weights are not known apriori and have to be selected through a process of search. The degree of match value can be used as a score to be minimized while incrementally varying the weights from an initial state. The degree of match value is a measure of similarity of the generated texture according to the estimated third texture parameters to the original texture as it is present in the image. A feedback mechanism can be advantageously employed to control the selection of weights depending upon the measure of similarity in an adaptive fashion. An optimum set of weights can be iteratively and adaptively selected in order to converge to a predefined degree of match value.

In a further embodiment of the image encoder according to the invention, the comparator is arranged to apply as a pre-defined matching function, a psycho-visual matching function, taking as input, the representation of the generated texture and the representation of the available texture, both the representations being defined over a number of pixels and yielding as an output the degree of match value.

The comparator is arranged to apply a psycho visual matching function for comparing the generated texture with the available texture. Psycho-visual matching functions are often used to emulate human visual system for assessing visual quality of images. A psycho-visual matching function can be specially designed to compare two textures represented over a number of pixels and generate a degree of match value to indicate the measure of similarity of textures. The degree of match value can be used to decide whether the available texture can be replaced with the generated texture such that the distortion is barely perceptible to the human eye. The advantage of using a psycho-visual function in this invention is that the available texture is replaced with the generated texture with some amount of pre-decided visual quality.

In a further embodiment of the image encoder according to the invention, the comparator is arranged to apply as a pre-defined matching function, a statistical matching function, taking as input, a statistical property of the representation of the generated texture and a statistical property of the representation of the available texture, both the representations being defined over a number of pixels and yielding as an output, the degree of match value.

When two textures represented by a region of pixels have to be compared for similarity, a number of well known statistical properties can be compared. The statistical properties can range from basic properties to more advanced statistical properties. Some examples of basic statistical properties are mean, variance, standard deviation, moments, entropy, correlation, moments and measures derived from co-occurrence matrices. More advanced statistical properties such as uniformity measures and energy clustering measures may also be considered. A combination of such statistical properties can be used to obtain a degree of match value representing similarity of two textures.

In a further embodiment of the image encoder according to the invention, the comparator is arranged to apply as the pre-determined matching criterion, a distance measure function taking as input, the third texture parameter and the texture parameter of a texture present in the third region and yielding as an output the degree of match value.

When the parameters of two textures are represented as two vectors, a distance measure may be applied to calculate the degree of match between the two vectors. A distance measure can be suitably transformed to represent the similarity of the two textures in the form of a degree of match value.

In a further embodiment of the image encoder according to the invention, the encoder is arranged to encode video information comprising a temporal sequence of images.

The invention can be applied to images of temporal sequence in a video or any sequence of images particularly when the textures in the images are inter-related or similar. In image sequences, intra as well as inter texture estimation from the related textures present in adjacent images is possible. As a result, coding of image sequences comprising textures can also be advantageously carried out using texture parameters and estimating algorithm.

In a further embodiment of the image encoder according to the invention, the image encoder is arranged to encode a first image comprising the first region, a second image comprising the second region and a third image comprising the third region wherein the first image and the second image are temporally adjacent to the third image.

The third texture whose parameters are to be estimated need not be comprised in the same image and can be comprised in one of the temporally adjacent images that contain the related textures for e.g., first and the second region of textures. Thus the invention can be advantageously applied to video sequences and image sequences that may contain related textures.

It is further desirable to provide a method of image encoding as which provides a method of encoding an image comprising at least one of a first region, a second region and a third region, in a more efficient manner.

This is achieved in that the method of encoding an image comprising at least one of a first region and a second region, and a third region, the method of encoding comprises:

estimating a third texture parameter from at least one of a first texture parameter of the first region and a second texture parameter of the second region according to a predetermined estimating algorithm.

comparing a representation of a generated texture corresponding to the estimated third texture parameter with a representation of a texture present in the third region of the input image, according to a pre-determined matching criterion and calculating a degree of match value; and

encoding at least one of the first texture parameter and the second texture parameter into a compressed data stream and encoding the texture present in the third region of the input image with a codification of the estimating algorithm in the compressed data stream when the degree of match value is within a pre-specified interval.

Estimating algorithm for estimating parameters of the third texture from the parameters of the first and second textures is codified instead of the parameter itself, saving substantial amount of bit-rate. The generated third texture according to the estimated parameter is compared with the available third texture to yield a degree of match value. If the degree of match value is within a predefined limit, the quality of reproduction can be assumed to be within acceptable limits. In such cases, instead of encoding and transmitting the parameters of the third texture, the estimating algorithm is codified and transmitted resulting in efficient reduction of bandwidth and storage space for the image or image sequence.

It is further desirable to provide an image decoder for decoding a compressed data stream in a more efficient manner.

This is achieved in that the image decoder for decoding a compressed data stream comprising a codification of an estimating algorithm into an image comprising at least one of a first region, a second region and a third region, the image decoder comprising,

a data decoder arranged to decode a first texture parameter of the first region and a second texture parameter of the second region from the compressed data stream;

a detector for detecting the codification of the estimating algorithm from the compressed data stream;

an estimator for estimating a third texture parameter of the third region from at least one of the first texture parameter and the second texture parameter according to a predetermined estimating algorithm as indicated by the estimating algorithm.

The image decoder can be arranged to decode the first and second texture parameters and from the codification of the estimating algorithm, the third texture parameter can be estimated and the textures can be synthesized from the parameters. The decoder is equipped with a detector mechanism for detecting the codification of the estimation criterion. Based on the estimating algorithm, the third texture parameters are calculated. The load of decoding the third texture parameters is reduced. Thus the decoding efficiency is improved in the decoder according to the invention.

It is further desirable to provide a method of image decoding a compressed data stream in a more efficient manner.

This is achieved in that the method of decoding a compressed data stream comprising a codification of an estimating algorithm into an image comprising at least one of a first region, a second region and a third region, the method comprising:

decoding a first texture parameter of a first region of texture, a second texture parameter of a second region of texture from the compressed data stream;

detecting the codification of the estimating algorithm from the compressed data stream;

estimating a third texture parameter from at least one of the first texture parameter of the first region and the second texture parameter of the second region according to a predetermined estimating algorithm as indicated by the estimating algorithm.

The method of decoding according to the invention comprises decoding the first texture parameter and the second texture parameter. The third texture parameter is estimated from the first and second texture parameters after detecting the codification of the estimating algorithm.

In a further embodiment of the image encoder for encoding at least one image according to the invention, the image encoder comprises:

a first part of the encoder arranged to encode the at least one image comprising at least one image object into a first part of a compressed data stream conforming to a predefined image compression standard and;

a second part of the encoder arranged to encode the regions of texture into a second compressed data stream comprising encoded parametric data of the first and second texture parameters and a codification of an estimating algorithm for estimating the third texture from the first and second textures,

wherein the first and second compressed data streams are interleaved to represent a combined data stream conforming to the predefined image compression standard.

Some images contain objects in the presence of large amount of background textures, for example, football field with players. In such images, it is advantageous to compress the foreground objects and background textures separately in two parts of the encoder and combine the compressed data streams of the two parts to form a single data stream. The second part of the encoder for encoding the multiple textures is built according to the invention. This scheme can result in considerable amount of bit-rate saving as the texture can be reproduced with much lesser number of bits than otherwise required by conventional compression schemes.

Since the first part of the compressed data stream is conforming to one of the well-known image compression standards, conventional decoders can still decode the compressed data stream into objects with a coarse background. Hence the embodiment of the encoder according to the invention can be optionally comprised in conventional decoders of well-known image compression standards.

It is further desirable to provide a transmitter, for transmitting a compressed data stream obtained by encoding at least one input image comprising regions of texture.

This is achieved in that the transmitter for transmitting a compressed data stream obtained by encoding at least one input image comprising regions of texture, the transmitter comprises:

a texture modeling unit arranged to model a texture of a region of texture, by means of a pre-defined model such as a two dimensional auto-regressive model, estimate a texture parameter of the model and encode information of the model into a compressed data stream;

an image encoder arranged to receive the texture parameter, and the representation of at least one texture available in the image, and arranged to encode the texture parameter and the codification of estimating algorithm further into the compressed data stream; and

a transmission unit, arranged to transmit the compressed data stream to a data transmission entity or a storage entity.

The transmitter comprises a texture-modeling unit in which the regions of texture can be segmented and their texture parameters estimated. The transmitter further comprises an encoder arranged to estimate the third texture parameter from the first and the second texture, compare the generated third texture with the available third texture and encode the estimating algorithm into a compressed data stream when the degree of match value is within a predefined interval. Thus the bandwidth of the compressed data stream is reduced compared to conventional systems. The transmitter further comprises the transmitter unit that converts the compressed data stream compatible to the transmission medium, for example, wired, wireless or internet. The transmitter of the invention can receive the image sequences and transmit them at a lesser bandwidth than a prior art transmitter that encodes all the texture parameters and hence is more efficient. The transmitter according to the invention for transmitting video sequences can be located at various broadcasting options such as: at the head end of cable operator or a wireless broadcast station or Direct-to-Home broadcast stations or internet servers.

It is further desirable to provide a portable device for storing and/or transmitting an encoded version of an image in a more efficient manner.

This is achieved in that the portable device comprising:

a camera arranged to capture at least one image;

a transmitter according to the invention arranged to transmit an encoded version of the at least one image to a data transmission entity or a storage entity.

The portable device may comprise a camera and a transmitter according to the invention. The camera can provide a sequence of images that are to be stored or transmitted. A transmitter according to the invention can convert the sequence of images into a compressed data stream. The transmitter of the portable device is similar to the transmitter explained in the preceding paragraphs according to the invention. The transmitter is arranged to reduce the bit-rate and storage space according to the invention, compared to a conventional transmitter. As a consequence, the portable device can be advantageously used in a bandwidth limited or storage-limited applications. Examples of such devices are, mobile phone with a camera, personal digital assistant (PDA) with a camera or a digital still/video camera. In all the possible examples, it is also possible to have a storage media for storage of images or transmitter for transmission of image sequences. When using the word transmitter we mean to comprise transmission to a storage memory (according to its data standard), e.g. a memory stick, etc.

In an embodiment of the image decoder according to the invention, the image decoder is arranged to decode a compressed data stream into at least one image, the image decoder comprising:

a first part of the decoder arranged to decode a first part of the compressed data stream conforming to a predefined image compression standard into at least an image object; and

a second part of the decoder arranged to decode a second part of the compressed data stream comprising a codification of an estimating algorithm and parameters of regions of texture,

wherein the second part of the decoder is further arranged to synthesize the regions of texture from the parameters of regions texture and add the regions of texture to the image object to yield an output image.

The decoder can decode a compressed data stream conforming to a well-known image compression standard. The first part of the compressed data stream when decoded may yield the image objects and the second part of the compressed data stream, encoded according to the invention may yield regions comprising textures and both the outputs are added to form the output image. The decoder is arranged to decode the first part of the compressed data stream, and be compatible to compressed data streams of known standards.

It is further desirable to provide a receiver for receiving a compressed data stream comprising an encoded version of at least one image outputting at least one image in a more efficient manner.

This is achieved in that the receiver for receiving a compressed data stream comprising an encoded version of at least one image from an image transmission or storage utility, the receiver comprising:

a decoder according to the invention arranged to decode the compressed data stream into at least one output image;

an output means arranged to connect the output image to a comprised or connectable display.

The image decoder according to the invention is comprised in a receiver for receiving a compressed data stream and outputting at least one image. The receiver is arranged to receive a compressed data stream conforming to a known video compression standard and/or a compressed data stream comprising texture parameters and a codification of an estimating algorithm and output the sequence of images. The receiver may comprise a display or it may have means for coupling to an external display. The invention can be used in one of the many receivers for example, television receiver, home theatre system, set top box, personal computer with or without internet connection and portable devices such as media center, portable video player, personal digital assistant (PDA) and mobile phone.

It is further desirable to provide a compressed encoded image signal that compresses an image sequence in a more efficient manner.

This is achieved in that the compressed encoded image signal comprises:

data encoding an image object present in an image on basis of a linear transformation of pixel values of groups of pixels comprised within an image object, according to a predefined image compression standard;

parametric data encoding a texture region comprised within the image; and

a codification of a model for generating further texture parameters on basis of the parametric data encoding the texture, usable for regenerating a further texture of the image.

A compressed encoded image signal conforming to a well known standard of image compression is suitably modified to accommodate the additional components for e.g., codification of a model for generating further texture from the transmitted parameters of textures. An additional codification of a model for generating a further texture on basis of parameters of texture arranges the image signal to be more efficient in terms of bit rate reduction compared to a standard image compression signal. While decoding in conventional decoders, the additional components can be discarded and the regions of texture with received parameters will only be synthesized. The image signal thus generated can still be in conformance to conventional decoders.

It is further desirable to provide a method of transmission of a compressed encoded image signal in a more efficient manner.

This is achieved in that the compressed encoded image signal comprises a codification identifying a model for generating further texture parameters on basis of parametric data encoding a first texture region comprised within an image, usable for regenerating a further texture region comprised within the image, the method comprising:

encoding an image object present in the image on basis of a linear transformation of pixel values of groups of pixels comprised within the image object, into a compressed encoded image signal according to a predefined image compression standard;

encoding the first texture region comprised within the image by means of parametric data;

encoding codification of the model for generating further texture parameters on the basis of the parametric data, usable for regenerating the further texture of the image;

transmitting the encoded compressed data stream over the wired or wireless medium of data transmission.

The method of transmission of a compressed encoded video signal according to the invention comprises a step of encoding the codification of the model for generating further texture parameters on basis of parameters of the first texture. Thus the method of encoding saves bit-rate by encoding the model of regeneration of textures instead of the texture parameters themselves. Hence the method is more efficient than conventional methods of encoding textures of images.

It is further desirable to provide a computer program product enabling a processor to execute a method of encoding an image in an efficient manner.

This is achieved in that the program product to be loaded by a computer arrangement, comprising instructions for compressing an image comprising regions of texture into a compressed data stream, the computer arrangement comprising processing unit and a memory, the computer program product, after being loaded, providing said processing unit with the capability to carry out the following tasks:

estimating a third texture parameter from at least one of a first texture parameter of the first region and a second texture parameter of the second region according to a predetermined estimating algorithm;

comparing a representation of a generated texture corresponding to the estimated third texture parameter with a representation of an available texture of the third region, according to a pre-determined matching criterion and calculating a degree of match value; and

encoding the first texture parameter and the second texture parameter into a compressed data stream and encoding the texture present in the third region with a codification of the estimating algorithm in the compressed data stream when the degree of match value is within a pre-specified interval, thereby compressing the image.

A computer program product comprising step-by-step instructions for executing the method according to the invention increases the efficiency of encoding by encoding the estimation criterion instead of the parameters of the texture thereby reducing the bit-rate. The computer program product is useful in achieving a better compression than a program that encodes all the texture parameters. The computer program is a versatile tool that can be applied on various platforms to effectively implement the method of encoding. The computer program product can be used in various forms of consumer apparatus and devices, for example, set top boxes, video receivers, recorders, players, hand-held devices and mobile devices. The computer program product can be built in one of these devices on various platforms, for example, operating systems (OS) of PCs, hand-held devices, video players or in any one of the well known embedded systems or on java virtual machines.

In an embodiment of the image encoder according to the invention the images are manually segmented to obtain regions of texture.

Textured regions in images can be hand segmented to obtain relatively more accurate and meaningful regions than machine-segmented regions. Manual segmentation is useful in case of repetitive scenes and textured segments occupying large part of the scene, for e.g., grass in a football field.

The technique of texture estimation and interpolation can be advantageously applied in integrating images with graphic settings and background; for example, computer graphics work at the production side.

In an embodiment of the image encoder according to the invention, the images are pre-segmented by means of an image segmentation algorithm to obtain regions and parameters of texture.

Applying one of the classical segmentation approaches for e.g., split and merge or recursive histogram splitting or region growing can automatically segment images. The algorithms can be implemented in software or hardware in a computing machine. Images can be pre-segmented by assuming and testing fitness of parametric models with the available texture and in the process, regions can also be segmented. A split and merge approach can be used in a second iteration to refine the parameters of the models of refined segments. Regions of textures and parameters of textures can be directly applied to the encoder according to the invention to further encode the parameters of textures. Automated segmentation with parametric models is faster than first segmenting and finding the parameters of textures of regions. Automated segmentation may be optionally arranged to obtain regions of regular shapes and sizes for example, a square region of 16×16 pixels or a rectangular region of 16×32 pixels.

The above object and desirable features of the present invention will be more apparent from the following description of the preferred embodiments with reference to the drawings, wherein:

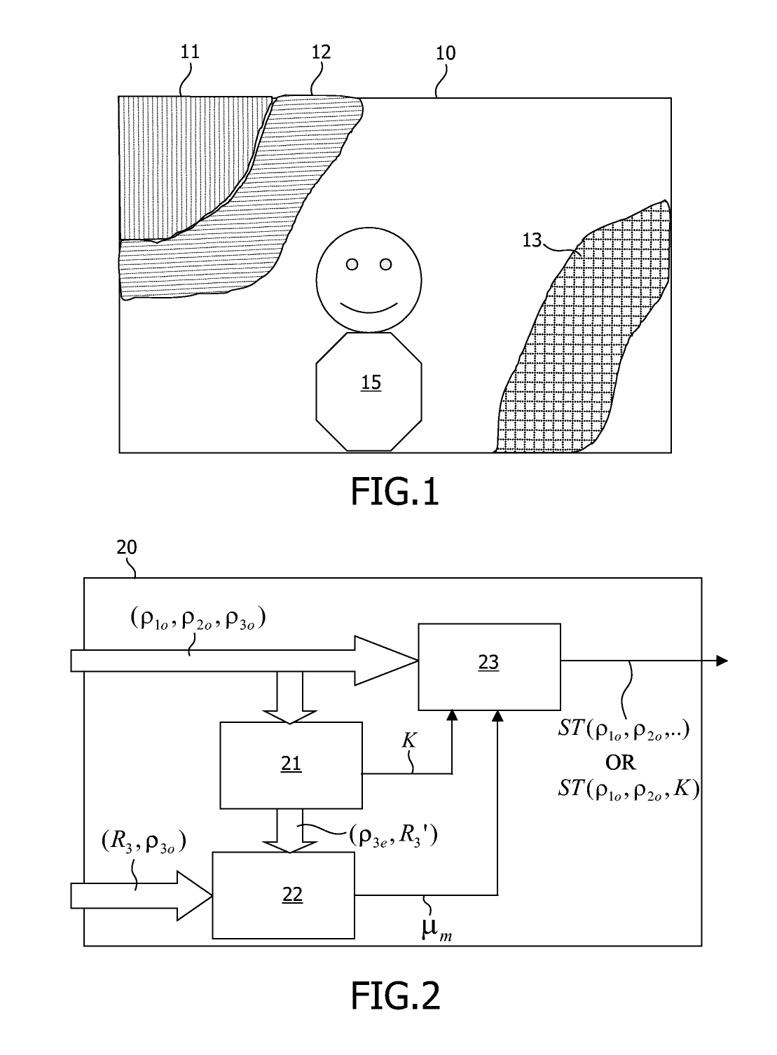

FIG. 1 is a schematic illustration of an example image with regions of texture.

FIG. 2 is a schematic illustration of an embodiment of an image encoder according to the invention.

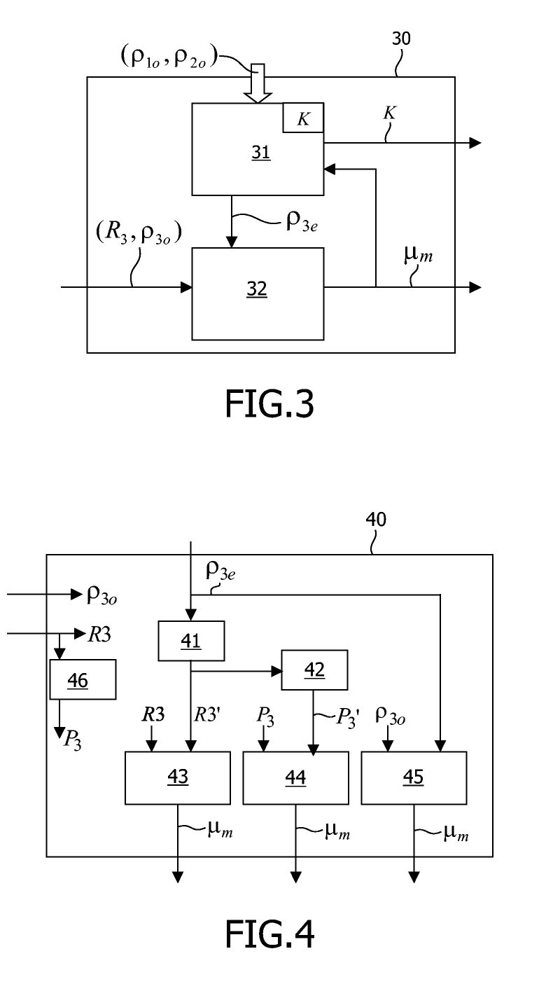

FIG. 3 is an illustration of exemplary unit 30 comprising an estimator and a comparator of an image encoder according to the invention.

FIG. 4 is a schematic illustration of a block diagram of an embodiment of a comparator according to the invention.

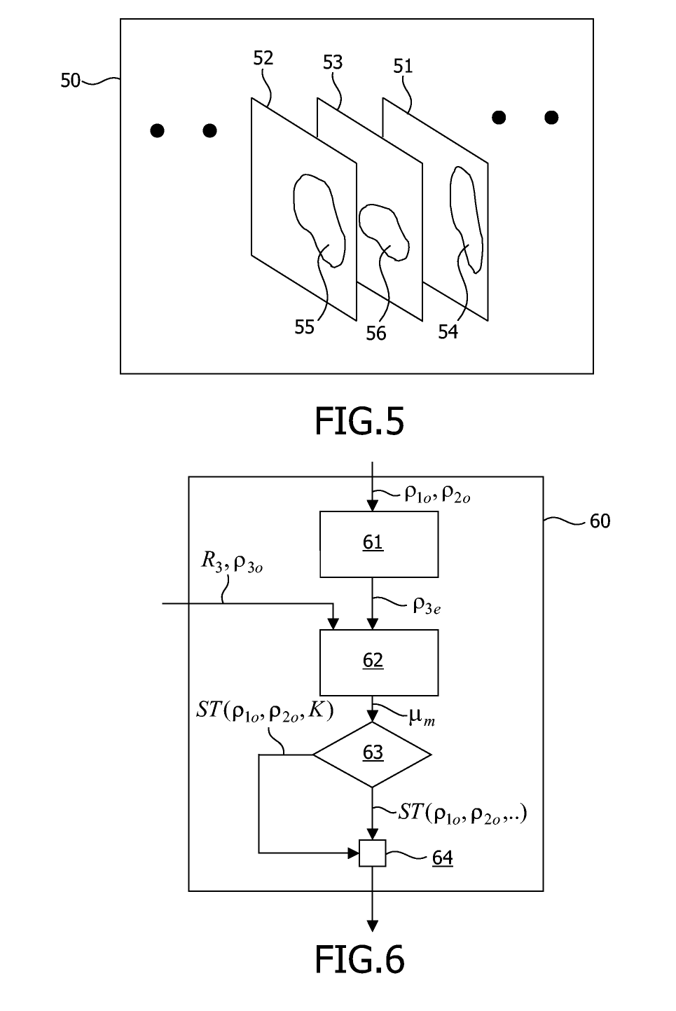

FIG. 5 is a schematic illustration of a video sequence of images comprising regions of textures.

FIG. 6 is an illustration of a flow diagram of an embodiment of a method of encoding an image according to the invention.

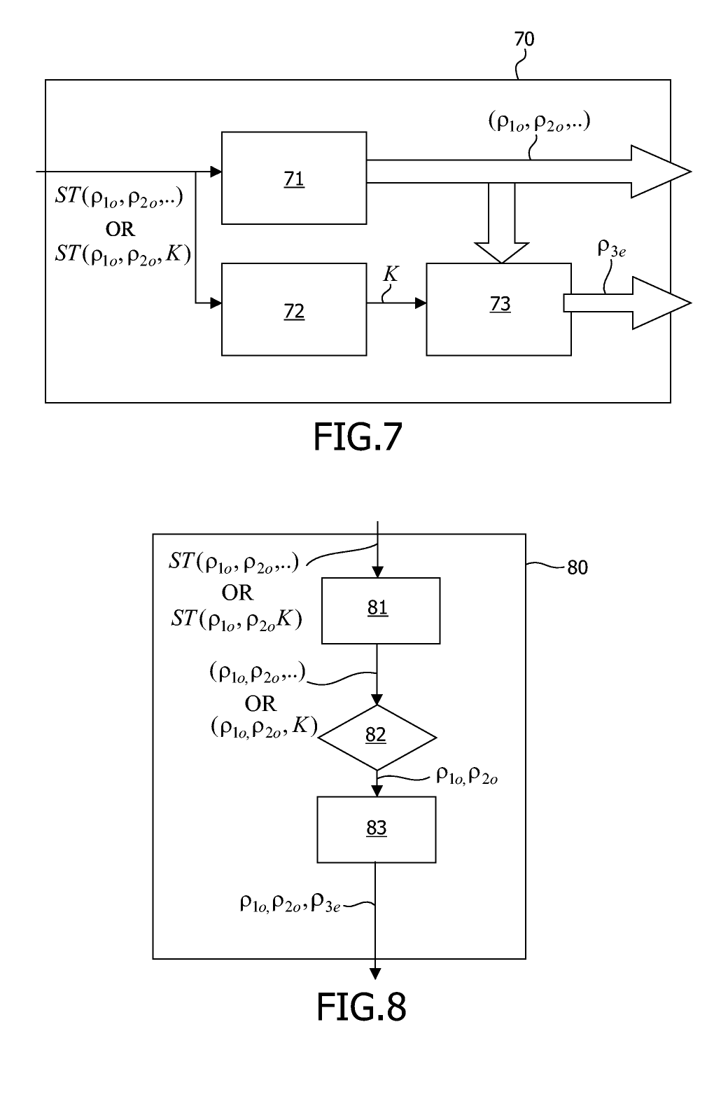

FIG. 7 is a schematic illustration of a block diagram of an embodiment of an image encoder according to the invention.

FIG. 8 is an illustration of a flow diagram of an embodiment of a method decoding an image according to the invention.

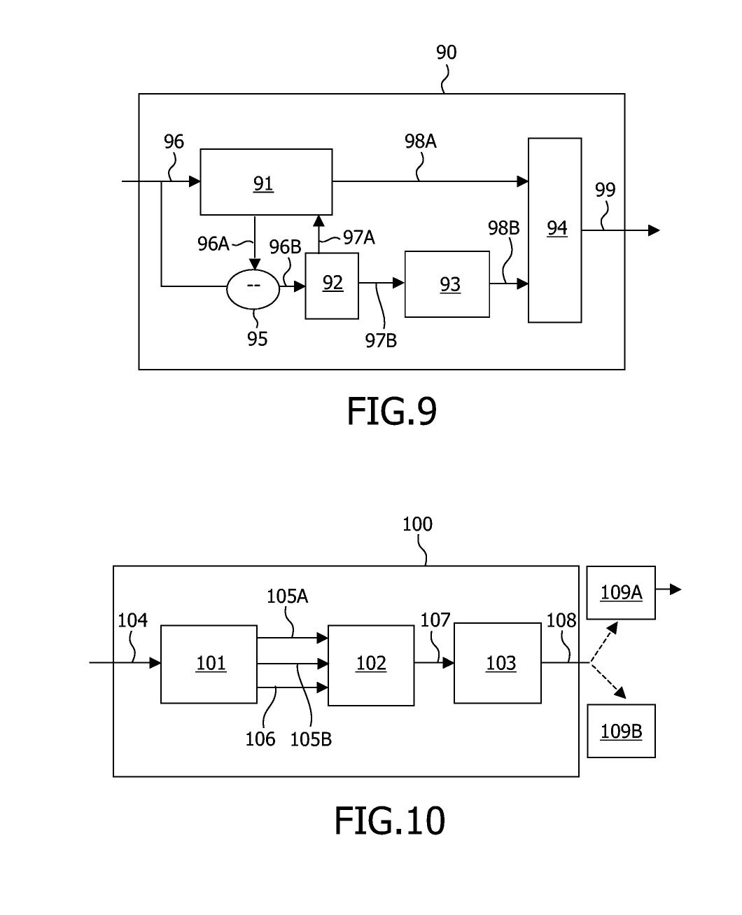

FIG. 9 is a schematic illustration of a block diagram of an embodiment a image encoder according to the invention.

FIG. 10 is a schematic illustration of a block diagram of an embodiment of a transmitter for transmitting a compressed data stream according to the invention.

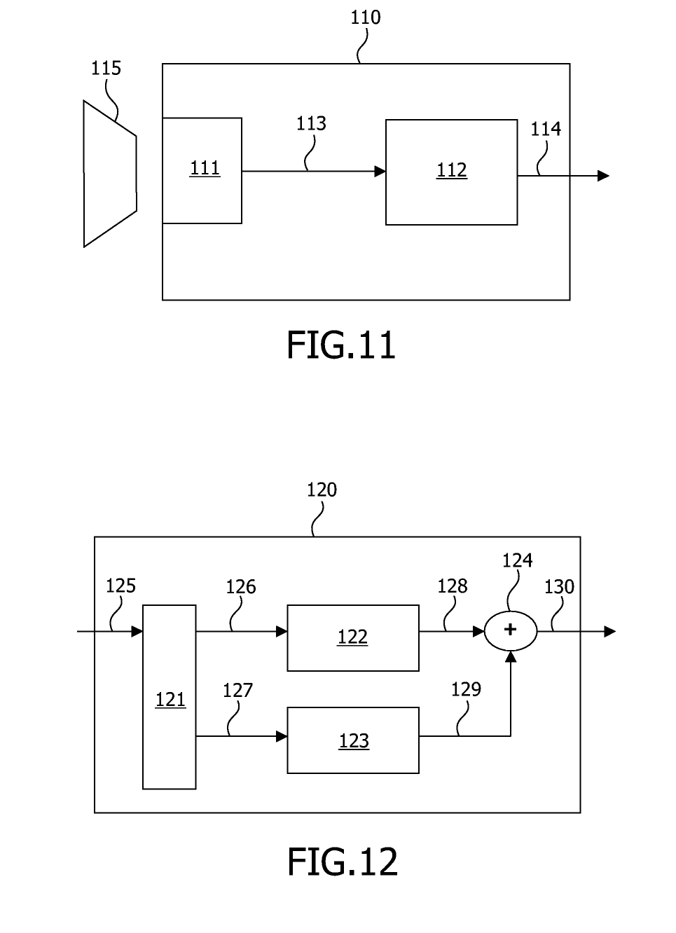

FIG. 11 is a schematic illustration of a block diagram of an embodiment of a portable device in accordance with an embodiment of the invention.

FIG. 12 is a schematic illustration of a block diagram of an embodiment of an image decoder according to the invention.

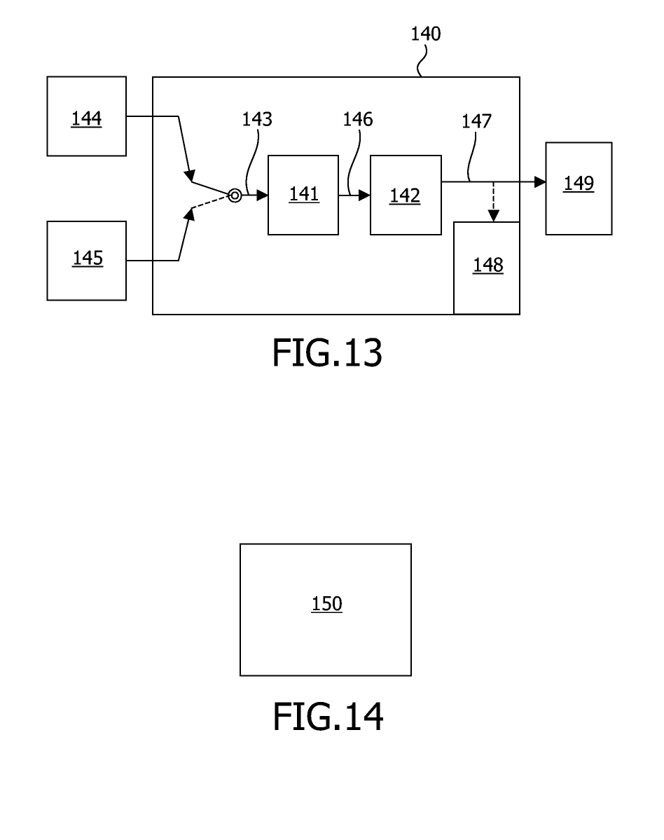

FIG. 13 is a schematic illustration of a block diagram of a receiver according to the invention.

FIG. 14 is a schematic illustration of block diagram of a computer program product according to the invention.

Image sequences are encoded and compressed to reduce the size of data needed for their transmission and storage. The compression ratio achieved may directly affect the decoded image quality for instance, a higher compression ratio may result in a poor quality of decoded image. Textures in images have some spatially homogeneous properties and typically comprise repeated structures often with some random variations for example random positions, orientation or colors. Textures are assumed to be stationary when important statistical signal properties of the texture do not depend upon the position in the image. Compressing images with regions of texture poses additional challenges while trying to achieve higher compression ratios for achieving good quality of decoded images.

FIG. 1 is a schematic illustration of an example image 10 with regions of texture. The image 10 comprises an image object, for example a human being 15 in foreground and three regions of textures 11, 12, and 13 in background. A region of texture 13 may be similar to regions of texture 11 and 12. The region of texture 13 which resembles, related to or dependent on at least one of the textures 11 and 12 may appear anywhere in the image. For example, the region of texture 13 may appear adjacent to both the resembling textures 11 and 12 or it may appear detached. Thus textures in images can be grouped for similarity and inter-dependency. A texture that closely resembles one or two textures is a good candidate for reconstruction with estimated parameters of resembling textures.

A region of texture 13 may also vary gradually from one end to the other, resembling one texture 11 at one end and the other texture 12 at the other end. In some class of images, a texture in a large region may comprise variable sizes of the elements that make up the texture. They may sometimes be referred to as varying from coarse grain to fine grain textures. The texture grain structure that varies gradually from one boundary to another boundary of the region is also a good candidate for reconstruction with estimated parameters for example statistical parameters that represent the resembling textures.

A texture may be analyzed and a parametric model fitted to the texture. The texture may be characterized with the help of parameters obtained from the model. Therefore it may be sufficient to encode the model parameters in the compressed stream so that the texture can be synthesized and reconstructed at the appropriate location of the image. The location and the boundary information of the texture may be required to be sent. The boundary information may be optionally encoded to achieve data compression for example, by approximation of a boundary to a geometric figure or by a description of boundary using polynomial functions, Fourier descriptors or fractal geometry.

Boundary information is not needed in every embodiment as e.g. a background grass texture in a pre-fixed image subpart can be completed from any starting texture upon which foreground objects may be superimposed. Strategies may be applied to smoothen the transfer of the texture in the foreground objects and the parametrically generated background texture according to the present invention.

In general, it is possible to generate a realization of a texture with the same statistical properties as those of an original texture. It is also possible to generate an intermediate or gradually varying texture from one or more of related or dependent textures from their model parameters. Reduction in bit-rates can be achieved in such cases, compared to the encoding of the model parameters of all the regions of textures present in the image.

FIG. 2 is a schematic illustration of a block diagram of an embodiment of an image encoder 20 according to the invention.

The image encoder 20 comprises an estimator 21, a comparator 22 and a data encoder 23. The image encoder is arranged to receive texture parameters of regions of texture. A texture parameter is a representation of a texture and can be used for regenerating the texture. There are various ways of estimating texture parameters of regions of texture. A texture parameter of a stochastic representation of a texture, for example may be obtained by finding its most resembling parametric model. The texture parameter may additionally comprise representation of boundary information of the region of texture.

The image encoder 20 is arranged to encode an image 10 shown in FIG. 1 comprising at least one of a first region 11, a second region 12 and a third region 13. The estimator 21 is arranged to receive at least one of a first texture parameter (ρ₁ₒ) of the first region and a second texture parameter of the second region (ρ₂ₒ) and estimate a third texture parameter (ρ₃ₑ) according to a predetermined estimating algorithm (K). The estimating algorithm can be a simple one such as averaging of texture parameters to a more complex one such as a polynomial non-linear equation of texture parameters. A weighted averaging of texture parameters can be advantageously used as an estimating algorithm.

A segmentation means for receiving an input image and segmenting the textured regions and computing the texture parameters can be provided outside the encoder or as an additional module inside the encoder. Segmentation can be combined with the parameter estimation of the textured regions or it can be advantageously carried out in stages. Prediction and correction of the parametric models such as auto-regressive moving average (ARMA) model can be used for segmentation and parameter estimation. Refinements of segmentation through split and merge or any other well-known procedure can also be comprised in the segmentation module. The segmentation could be an automated segmentation applying any one of the well-known techniques such as histogram splitting.

An example of model fitting and parameter estimation of a textured region is presented. Consider a texture R₁ which is a function X of the position (m,n). The texture is assumed to be stationary. Some useful statistical parameters for such a texture may be mean and auto-covariance. In this example, an estimation of auto-covariance parameter ρ₁ is illustrated. For ease of notation, it may be further assumed that the mean is zero. For a non-zero mean case, the mean may be estimated and subtracted. The auto-covariance is defined as the covariance between two observations X(m₀,n₀) and X(m₀+Δm,n₀+Δn), where (Δm,Δn) are incremental shifts to co-ordinates (m₀,n₀)

ρ₁(Δn,Δm)=E{X(m₀,n₀)X(m₀+Δm,n₀+Δn)} (1)

The property of stationary gives rise to ρ₁ being independent of the position (m₀,n₀), and dependent only on the relative position (Δm,Δn) of the two observations. The variance is given by auto-covariance at shift of coordinates (0,0)

σₓ²=ρ₁(0,0) (2)

A 2-dimensional auto regressive (2D AR) model can be used to obtain a compact representation of the statistically significant details in the texture covariance function. A 2D AR model for a texture X is given by the following difference equation:

$$X ( m , n ) + {\sum }_{( i , j ) ∈ S} {a}_{i , j} X ( m - i , n - j ) = ɛ ( m , n ) \qquad ( 3 )$$

where X is the texture and ε(n,m) are zero-mean independent identically distributed random variables. The surrounding area S used in the summation is defined as the region of support (ROS). The point (m,n) may be referred to as central point in the region of support. The summation is a linear combination of surrounding values of observations X(m,n) with coefficients a_{i,j}.

The AR model parameters a can be used for prediction of \hat{X}(m,n) based on surrounding pixels:

$$\hat{X} ( m , n ) = - {\sum }_{( i , j ) ∈ S} {a}_{i , j} X ( m - i , n - j ) \qquad ( 4 )$$

The a_{i,j} are related to the auto-covariance by the 2-D Yule-Walker equations:

$${\sum }_{( i , j ) ∈ S} {a}_{i , j} {ρ}_{1} ( k - i , l - j ) = \{ \begin{matrix}{σ}_{ɛ}^{2} & for ( k , l ) = ( 0 \text{,} 0 ) \\ 0 & otherwise\end{matrix} \qquad ( 5 )$$

Further techniques exist in the literature of model fitting for determining model order and optimal coefficients.

It is possible to obtain regions of texture by manual segmentation. Such regions can be further processed for obtaining texture parameters. Manual segmentation has several advantages: semantically meaningful regions can be obtained in a single iteration; errors of segmentation can be much lesser compared to automatic segmentation; and manual segmentation may suit well for static and repetitive scenes.

The comparator 22 is arranged to compare a generated texture corresponding to the estimated third texture parameter (ρ₃ₑ) and the third texture 13 (R₃) as available in the image 10 shown in FIG. 1. Different embodiments of the comparator are arranged to compare the textures starting from different possible representations and generate a measure of similarity, which is called a degree of match value (μm). The degree of match value is useful in deciding whether the third texture can be replaced with a texture generated by the estimated texture parameter.

A generate-and-test strategy is adopted for finding the fitness of the generated texture to the texture as found in the image. The degree of match value can be calculated by comparing the textures by means of a statistical matching function or a psycho-visual matching function. When the degree of match value is within a certain interval, it is an indication of satisfactory estimation of the third texture parameters from the other texture parameters and a decision to substitute the third texture parameters with the estimating algorithm can be arrived at. A decision may also be taken when the degree of match value is above a predetermined threshold value.

As an example, suppose an area with a gradually changing texture from left to right is modeled using two 2-dimensional auto regressive (AR) models M₁ and M₂, which are fitted to the left and right half of the texture area. In the transition area, a transition model M₃ between the models M₁ and M₂, is expected to fit better than either M₁ or M₂.

An intermediate model could be determined for this transition region. However, this new model yields additional parameters that have to be transmitted to the decoder, increasing the bit rate. An alternative is to estimate the parameters of the model M₃ by a combination of available model parameters M₁ and M₂, for example, by interpolation of the model parameters M₁ and M₂. Estimation may yield a more accurate model for the transition region, compared to M₁ or M₂, without increasing the bit rate. Many equivalent representations for the model parameters are available, such as autocorrelation coefficients, reflection coefficients and prediction parameters.

Further in the example, auto-covariance coefficient ρ₃ₑ of the model M₃ can be obtained by a weighted averaging of auto-covariance coefficients ρ₁ and ρ₂ of the models M₁ and M₂, with weights (w₁,w₂).

ρ₃ₑ=w₁ρ₁+w₂ρ₂ (6)

The corresponding model parameters are denoted a_{Ii,j}. These model parameters can be found by solving the Yule-Walker equations for ρ₃ₑ:

$${\sum }_{( i , j ) ∈ S} {a}_{Ii , j} {ρ}_{3 e} ( k - i , l - j ) = \{ \begin{matrix}{σ}_{ɛ}^{2} & for ( k , l ) = ( 0 \text{,} 0 ) \\ 0 & otherwise\end{matrix} \qquad ( 7 )$$

The quality of an interpolated model for a specific segment R₃ can be evaluated by calculating the fit of this model to the data. This fit is the mean square value of the residual r:

$$F = \frac{1}{\vert {R}_{3} \vert} {\sum }_{( i , j ) ∈ {R}_{3}} {r}^{2} \qquad ( 8 )$$

where r is given by the difference between the statistical properties Y(m,n) of true texture X(m,n) and statistical properties Ŷ(m,n) of predicted texture \hat{X}(m,n) where (m,n) are the coordinates.

r=Y(m,n)−Y(m,n) (9)

In more general terms, the residual r can be used to determine whether the texture in a particular region is suitable for texture synthesis. For example, if texture synthesis is done with a 2D-AR model with Gaussian white noise as an input, the residual r should have similar statistical properties. This can be verified by means of a statistical test.

The data encoder 23 is arranged to encode the first texture parameter and the second texture parameter (ρ₁ₒ,ρ₂ₒ) into a compressed data stream ST(ρ₁ₒ,ρ₂ₒ, . . . ). Inserting the parameter values in a formatted frame according to a known standard can form the compressed data stream. Alternately, the parameters can be compressed and encoded into a data stream. The data encoder is further arranged to code a texture present in the third region 13 with a codification of the estimating algorithm (K) when the degree of match value is within a pre-specified interval, instead of ρ₃ₒ. The texture parameters that can be estimated within certain amount of accuracy need not be encoded in the compressed data stream and as it is sufficient to encode a predefined, agreed symbol or a short code indicating the estimating algorithm, resulting in saving of bit-rate. Hence better compression of the image is possible compared to prior art wherein the texture parameters are encoded as such in the compressed data stream. In a decoder, an estimating algorithm corresponding to the received symbol can be chosen from a table of pre-determined estimating algorithms.

FIG. 3 is an illustration of an exemplary unit 30 comprising an estimator 31 and comparator 32 of an image encoder according to the invention.

The estimator 31 is arranged to receive the first texture parameter (ρ₁ₒ) and the second texture parameter (ρ₂ₒ) as inputs and estimate the third texture parameter (ρ₃ₑ) according to pre-determined estimating algorithm (K). A number of estimating algorithms can be previously stored in the estimator and one of the criterion (K) is applied for estimation of the third texture parameter, which in turn is coupled to the data encoder 23. The comparator 32 receives the estimated third texture parameter (ρ₃ₑ) and a representation of the third texture (R₃), compares them and calculates the degree of match value (μₘ) as an output. A texture parameter (ρ₃ₒ) derived from the available third region of texture is also made available at the comparator for comparison with the estimated texture parameter (ρ₃ₑ). The degree of match value (μₘ) can be fed back to the estimator so that the estimator 31 chooses a predetermined scheme of estimation in order to obtain the degree of match value within predetermined interval. The degree of match value may be increased or decreased to obtain the value to be within a pre-defined interval. Thus the estimator 31 can be designed to estimate the third texture parameter (ρ₃ₑ) effectively by applying a feedback control signal from the comparator 32.

FIG. 4 is a schematic illustration of a block diagram of an embodiment of a comparator 40 according to the invention.

An embodiment of the comparator 40 is arranged to compute the degree of match value (μₘ) by invoking at least one of the following possible matching functions as shown in FIG. 4. A psycho-visual matching function 43 or a statistical matching function 44 or a distance measure matching function 45 can be employed. It is possible to calculate the degree of match value (μₘ) by combining the outputs of one or more of these functions optionally.

The psycho visual matching function (PVMF) 43 is arranged to receive the third region (R₃) as available in the image and the third region (R₃′) corresponding to the estimated third texture parameter (ρ₃ₑ). A texture synthesizer 41 maybe optionally designed inside the comparator 40 for this purpose. PVMF is designed to emulate the match as perceived by a human eye. Some of the well-known PVMFs use the human visual system model to perceive two images represented in luminance domain and calculate a degree of match value as output. The characteristics of human visual system, for example, the frequency sensitivity at various frequencies, energy sensitivity at various frequencies and low frequency perception versus high frequency perception can be built into a weighting function to obtain an appropriate degree of match value as output.

A statistical matching function can be designed for statistical testing of textures. A statistical parameter estimator 46 can be optionally built into the comparator 40 for computing a first statistical parameter (P₃) from the available texture (R₃). Similarly, a second statistical parameter estimator 42 may be optionally built into the comparator 40 for computing a second statistical parameter (P₃′) from the reconstructed texture (R₃′). The statistical matching function 42 is arranged to receive the first statistical parameter (P₃) and the statistical parameter (P₃′) and compute the degree of match value (μₘ). Statistical parameters of a texture may vary from basic parameters such as mean, variance, standard deviation, co-variance, entropy and moments to more advanced parameters such as energy measures and relation measures.

An example of estimating a degree of match value through a statistical matching function is presented. A relative spectral error measure IR, for example may be a useful statistical matching function for comparing two regions of textures (R₃, R₃′) as given by the following equations.

$$\begin{matrix}f ( ω ) = Γ ( {R}_{3} ) & ( 10 ) \\ \hat{f} ( ω ) = Γ ( {R}_{3}^{′} ) & ( 11 ) \\ IR = \frac{0.5}{2 π} {\int }_{- π}^{π} {[ \frac{f ( ω ) - \hat{f} ( ω )}{f ( ω )} ]}^{2} d ω , & ( 12 )\end{matrix}$$

where f(ω) is the normalized spectral density of the available texture, \hat{f}(ω) is the normalized spectral density of the estimated texture and Γ is the transformation applied on the region of pixels to obtain normalized spectral density.

A linear transformation can be applied to IR in order to obtain a degree of match value. An advantage of this approach is that statistical properties of such a matching function can be easily calculated. A number of examples of such useful statistical matching functions have been described in “The Performance of Spectral Quality Measures” by Piet M. T. Broersen in IEEE Transactions on Instrumentation and Measurement, Vol. 50, No. 3, June 2001.

The distance measure function 45 can be arranged to receive a texture parameter (ρ₃ₒ) estimated from the texture present in the third region, and the third texture parameter (ρ₃ₑ) estimated from one or more other texture parameters. The texture parameters can be assumed to be vectors. Comparison in parametric domain is much more simpler than comparison in luminance domain. Moreover, the degree of match value (μₘ) can be effectively generated by a linear transformation. One of the examples of comparing two vectors is calculation of a tangent distance, or a dot product of the two vectors.

FIG. 5 is a schematic illustration of a schematic of a video sequence of images comprising regions of textures.

The invention can be applied to a single image or images in a sequence or a video sequence. An image sequence 50 comprising a first image 51, a second image 52 and a third image 53 is shown in FIG. 5. The first image 51 comprises a first region 54, the second image 52 comprises a second region 55 and the third image comprises a third region 56. It is possible to estimate a texture from one or more textures present in the same image or one or more textures present in the adjacent images. The adjacency of textures is an useful criterion in estimating a texture and the ordering of images is not important. It is possible to estimate textures in a sequence of still images as well, for example a sequence of pictures taken on a beach or in a football field. In such images, foreground may comprise objects, people, trees or buildings and background may comprise textures of grass or sand.

FIG. 6 is an illustration of a flow diagram of an embodiment of a method of encoding 60 an image according to the invention.

The first and second texture parameters (ρ₁ₒ,ρ₂ₒ) are received in the estimating step 61 and the third texture parameter (ρ₃ₑ) is estimated. In the next step 62, the estimated third texture parameter (ρ₃ₑ) is compared with the texture parameter (ρ₃ₒ) of the third texture (R₃), as present in the image. There can be many methods of comparing the textures, for example, comparison in the pixel domain, comparison in the modeled parameter domain or comparison in the statistical parameter domain. The output of any one of the comparisons is arranged to output a degree of match value (μₘ). There may be an optional method of combining more than one comparison output to obtain a degree of match value (μₘ). The degree of match value (μₘ) is tested in data-encoding step 63 to see whether the value is within a pre-specified interval. If the degree of match value (μₘ) is acceptable, the estimating algorithm (K) of the third texture parameter (ρ₃ₑ) is encoded in the compressed data stream ST(ρ₁ₒ,ρ₂ₒ,K), resulting in bit-rate saving. Otherwise, the texture parameter (ρ₃ₒ) corresponding to the texture present in the third region is encoded in the compressed data stream ST(ρ₁ₒ,ρ₂ₒ, . . . ). Both these compressed data streams are combined in a combiner 64. Thus, the image encoding method 60 generates a compressed data stream wherein the texture present in the third region is encoded by estimating algorithm (K), whenever the degree of match value (μₘ) is within a pre-specified interval.

Apart from being an elegant method, texture reconstruction from estimated parameters is found to be less complex and creates lesser artefacts compared to interpolation in luminance domain as often recommended by prior art.

FIG. 7 is a schematic illustration of a block diagram of an embodiment of an image decoder 70 according to the invention.

A compressed data stream ST(ρ₁ₒ,ρ₂ₒ, . . . ) is received by a decoder 71. The compressed data stream may comprise a codification of an estimating algorithm ST(ρ₁ₒ,ρ₂ₒ,K). The first texture parameter and the second texture parameter (ρ₁ₒ,ρ₂ₒ, . . . ) are decoded by the data decoder 71. A detector 72 is arranged to detect the codification of estimation criterion (K) from the compressed data stream. From the detected estimation criterion (K), the third texture parameter (ρ₃ₑ) is estimated [generated] write-up in an estimator 73 from at least one of the first and the second texture parameters (ρ₁ₒ,ρ₂ₒ). It is possible to estimate one or more texture parameters from at least one texture parameter according to the estimating algorithm detected from the data stream. The estimator does not come into operation as long as the estimating algorithm is not detected. In such cases, the data decoder continues to decode the texture parameters as received in the compressed data stream.

FIG. 8 is an illustration of a flow diagram of an embodiment of a method decoding 80 an image according to the invention.

The method of decoding 80 comprises a first step 81 of decoding the first and second texture parameters (ρ₁ₒ,ρ₂ₒ) from the compressed data stream ST(ρ₁ₒ,ρ₂ₒ, . . . ). The compressed data stream ST(ρ₁ₒ,ρ₂ₒ,K) sometimes comprises the codified estimating algorithm (K). In the next step 82, the decoded data stream is tested for the presence of the estimating algorithm. When the estimating algorithm is detected, the third texture parameter (ρ₃ₑ) is estimated from at least one of the first and second texture parameters (ρ₁ₒ,ρ₂ₒ) according to the estimating algorithm (K). Otherwise, parameters as decoded by the data decoder are taken for further processing, for example synthesis of textures.

FIG. 9 is a schematic illustration of a block diagram of an embodiment of an image encoder 90 according to the invention.

An image encoder 90 according to the invention comprises a first part of the encoder 91 that encodes an image according to a deterministic compression standard, for example H.264 or advanced video coding (AVC) standard. In such a scheme, image objects that may not fall in the category of regions of textures are subjected to a linear transformation, more specifically a DCT, and encoded into a compressed data stream 98A. The regions of textures can also be coarsely encoded in the compressed data stream 98A by assigning comparatively lesser number of bits than the image object. The resultant texture, when decoded by a standard decoder may appear flattened and sometimes known to be ‘having a plastic appearance’. A reconstructed image 96A supplied by the first part of the encoder 91 is subtracted from the original image 96 in a subtractor 95. The difference image comprises regions of texture 96B. The regions of texture 96B may comprise finer details of textures and may be taken up for parametric modeling.

A texture analysis module 92 is arranged to model the regions of textures 96B and estimate the model parameters. Regions of textures 97A that do not fit the model to a pre-specified accuracy can be coupled back to the first part of the encoder 91. Regions of textures 97B that fit the model to a pre-specified accuracy may be selected and coupled to the second part of the encoder 93. An example of assessing the fitness of a model to a texture is illustrated in equation (8). The texture analysis module 92 can optionally be built into the first part of the encoder 91 or the second part of the encoder 93.

In another embodiment, image objects and regions of textures 97B can be separated from the image 96 by means of a texture filter and coupled separately to the first part of the encoder 91 and the second part of the encoder 93 respectively. In an yet another embodiment, an image 96 can be directly applied to the texture analysis module 92 and the regions that do not fit to any one of the pre-specified model with a pre-specified accuracy may be considered as image objects 97A and coupled to the first part of the encoder. The regions of texture 97B that fit a specified model may be coupled to the second part of the encoder 93.

The second part of the encoder 93 according to the invention encodes regions of texture 97B with parameters and codification of estimation criterion wherever it is possible to estimate a texture parameter from at least one of the other texture parameters. A compressed data stream 98B comprising the encoded texture parameters and codification of estimation criterion are combined with the compressed data stream 98A generated by the first part of the encoder 91. A combiner unit 94 is arranged to interleave the two compressed data streams 98A, 98B and to generate the combined data stream 99 that can still be compatible to the deterministic compression standards. For example, the compressed data stream 98B from the second part of the encoder 93 can be included in the compressed data stream 98A compatible to advanced video coding (AVC) standards as supplemental enhancement information (SEI) message. The SEI message can comprise model parameters and codification of estimation criterion. Apart from these information, the SEI message may additionally comprise the region segmentation information, the index of texture models for regions, index of models used for estimating and estimated textures and estimation coefficients for example, weights of weighted average scheme for estimating the texture.

FIG. 10 is a schematic illustration of a block diagram of an embodiment of a transmitter 100 for transmitting a compressed data stream according to the invention.

The transmitter 100 comprises a texture-modeling unit 101 in which an image 104 is received and the regions of textures modeled and their texture parameters estimated. Segmentation and texture modeling can be combined or distinct processes. In case if the segmentation is a distinct process, it can be based on classical segmentation techniques based on uniformity of one or more of the statistical properties. One example of a basic segmentation can be found in the article “Dense structure from motion: an approach based on segment matching”, authored by F. Ernst, P. Wilinski and K. van Overveld, in the Proceedings of European Conference on Computer Vision, Copenhagen, Denmark, 2002. Various other parametric models for texture segmentation may be considered, for example auto-regressive model (AR), moving average model (MA), auto-regressive moving average model (ARMA) or fractal model. A texture segmentation based on deterministically coded base layer of a standard compliant encoder for example a H.264 encoder can also be considered.

The texture-modeling module may be further arranged to comprise a segment-refining module for obtaining visually more meaningful segmented regions. By comparing models for neighboring segments A and B, it is decided whether the segments belong to the same texture. In such cases, the regions are merged to form a single region and the model parameters are correspondingly updated. In some cases, when the segment comprise more than one region and the model fit results in substantial error, the segment is split into two or more regions and a model is refitted for each segment to see if the model results in substantial reduction in the residual error. A merge operation is again performed on the split segments. The procedure can be repeated to obtain a refined segmentation.

In another embodiment, the boundary of the regions can be approximated to a regular shape for example a square, rectangle or a circle by tolerating some amount of errors, as long as the approximation does not overlap or obscure objects present in the image. Such techniques can be employed to reduce the bit-rate substantially for encoding the boundary of the regions. As an example, one of the boundaries of the first region 11 depicted in FIG. 1 can be approximated my a stair-case-like structure and encoded with lesser number of bits. Similarly, boundary of the second regions 12 can be approximated by a rectangle as much as it does not occlude the object 15 present in the image. Bandwidth saved while encoding regular boundaries can be used for more accurate modeling of textures present within these regions 11, 12. Thus a trade-off of bandwidth or bit-rate between the boundary encoding and texture content encoding can be effectively implemented.

In another embodiment, the regions of texture for synthesis can be encoded using a combination of rectangular/circular bounding box and intensity and/or color intervals. For example, in order to represent the area of grass texture in a football field, a rectangular bounding box and a range of chrominance and luminance values (Y, U and V values) corresponding to a green background can be encoded to save a number of bits. A decoded based layer in the advanced video coding (AVC) standard, for example, can be segmented in a pre-determined manner.

In the texture-modeling unit 101, regions of textures 105A and their corresponding texture parameters 105B are generated. In addition, a compressed data stream 106 comprising the information of the texture model is generated. The output of the texture-modeling unit 101 comprising regions of texture 105A, their corresponding texture parameters 105B and a compressed data stream comprising the information of the texture models 106 are coupled to the encoder 102. The encoder 102 is arranged to estimate the third texture parameter from the first and the second texture, compare the generated third texture with the available third texture and encode the first and second texture parameters and estimating algorithm into the compressed data stream 106 when the degree of match value is within a pre-specified interval. The output of the encoder is a compressed data stream 107 comprising the texture parameters, estimating algorithm and the information of the texture model. The transmitter further comprises a transmitter unit 103 that optionally converts the compressed data stream 107 compatible to the transmission medium, for example, wired, wireless or Internet. The inclusion of information of the texture model into the compressed data stream can be carried out in encoder 102 or in the transmission unit 103. The signal bandwidth of the transmission signal 108 comprising the compressed data stream is lesser compared to prior art systems. The transmission signal 108 can be transmitted through an transmitting entity 109A for example an internet server or stored in a storage entity 109B such as a hard disk or optical storage device.

FIG. 11 is a schematic illustration of a block diagram of an embodiment of a portable device 110 in accordance with an embodiment of the invention.

The portable device 110 according to the invention comprises a camera 111 and a transmitter 112. The camera 111 can be a still camera or a video camera for capturing at least one image 115. The images 113 are received by the transmitter unit 112, converted into a transmission signal 114 comprising the compressed data stream.

FIG. 12 is a schematic illustration of a block diagram of an embodiment of an image decoder 120 according to the invention.

The image decoder 120 is arranged to receive an input compressed data stream 125 compatible to a well-known image compression standard and decode the data stream into at least one image. The image decoder comprises a splitter 121, a first part of the decoder 122 and a second part of the decoder 123. The splitter 121 is arranged to split the compressed data stream 125 into a first part of the compressed data stream 126, compliant to a well-known image compression standard. The second part of the compressed data stream 127 comprises the parameters of texture and the codification of estimation criterion according to the invention. The first decoder 122 is arranged to decode a first part 126 of the compressed data stream conforming to a predefined image compression standard into at least one image object 128. The second part of the decoder 123 is arranged to decode a second part 127 of the compressed data stream into texture parameters. The second part of the decoder 123 is further arranged to synthesize the regions of texture 129 from the texture parameters and add the regions of texture 129 to the image object 128 to yield an output image 130.

FIG. 13 is a schematic illustration of a block diagram of an embodiment of a receiver according to the invention.

A receiver 140 comprises a decoder 143, an output means 142 and a comprised display 148. The decoder, according to the invention is arranged to receive a compressed data stream 143 comprising coded texture parameters and codification of estimating algorithms. The compressed data stream can be received from a remote transmitter 144 or from an internal storage means 145. The internal storage can be internal to the receiver or co-located with the receiver. The internal storage can be a hard disc drive or optical storage devices such as digital versatile disc (DVD) or blu-ray disc. The receiver comprises a decoder 141 according to the invention. The decoder decodes the compressed data stream into at least one image 146 comprising regions of texture. The image 146 is converted into a format suitable for a comprised display 148 or connected display 149. Examples of a receiver are set-top-box, media center, personal digital assistant, mobile phone, television, home theatre, personal computer or DVD/Blu-ray disc players.

FIG. 14 is a schematic illustration of block diagram of a computer program product according to the invention.

The computer program product (150) can be loaded into a computing machine and capable of operating the machine comprising a processing unit and a memory, the computer program product, after being loaded, providing said processing unit with the capability to carry out the encoding procedure on an image comprising regions of texture and/or decoding procedure on a compressed data stream in order to obtain the image comprising regions. The computer program product can be handled in a standard comprised or detachable storage, for example a flash memory or a compact disk or a hard disk. The computer program product can be embedded in a computing machine as embedded software or kept pre-loaded or loaded from one of the standard memory devices. The computer program product can be designed in any of the known codes such as machine language code or assembly language code and made to operate on any of the available platforms such as personal computers or servers.

The inventor has also realized from his experiments that synthesizing texture for successive pictures comprising a related texture in a motion-compensated same region may lead to an annoying temporal fluctuation of the pattern (where ideally a stationary pattern—e.g. the local grass—should move along with the local motion).

This can be tackled in the encoder by encoding a motion-previous image texture and motion-compensating it.

The new present texture (where e.g. some shadow has now come over it) may be somewhat different, and may be encoded as a differential compared to the encoded one.

The motion-compensated past texture for the region X, may also be weighed with the newly generated texture (according to any criterion, e.g. motion-compensation of the past texture (e.g. warping)+an update texture), so that an optimal (visually pleasing) match between temporal consistency and trueness (to temporal inconstant phenomena, such as the sudden overshadowing) remains. The weighing strategy may be pre-optimized with user-panels.

Best fitting textures can be determined and their model parameters can then be encoded in a similar way as described above for the main embodiment.

A decoder will do the inverse.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. An image encoder (20) for compressing an input image (10), or images in a sequence, comprising at least one of a first textured region (11, 54) and a second textured region (12, 55), and a third textured region (13, 56), the image encoder comprising:
an estimator (21) arranged to estimate a third texture representing parameter (ρ₃ₑ) from at least one of a first texture representing parameter (ρ₁ₒ) of the first textured region (11) and a second texture representing parameter (ρ₂ₒ) of the second textured region (12) according to a predetermined estimating algorithm (K);
a comparator (22) arranged to compare a representation (R₃′) of a generated texture corresponding to the estimated third texture representing parameter (ρ₃ₑ) with a representation (R₃) of a texture present in the third textured region (13) of the input image according to a pre-determined matching criterion and to calculate a degree of match value (μₘ); and
a data encoder (23) arranged to encode at least one of the first texture representing parameter and the second texture representing parameter (ρ₁ₒ,ρ₂ₒ) into a compressed data stream ST(ρ₁ₒ,ρ₂ₒ, . . . ) and arranged to encode the texture present in the third textured region (13) of the input image, or sequence of images, with a codification of the estimating algorithm (K) in the compressed data stream ST(ρ₁ₒ,ρ₂ₒ,K) when the degree of match value (μₘ) is within a pre-specified interval.

2. An image encoder according to claim 1 wherein the estimator (31) is arranged to apply as the predetermined estimating algorithm (K) a weighted combination of the first texture representing parameter (ρ₁ₒ) and the second texture representing parameter (ρ₂ₒ).

3. An image encoder according to claim 2 wherein the estimator (31) is further arranged to select weights for the weighted combination adaptively by minimizing the degree of match value (μₘ).

4. An image encoder according to claim 1 wherein the comparator (40) is arranged to apply as the pre-determined matching criterion, a psycho-visual matching function (43), taking as input, the representation of the generated texture (R₃′) and the representation of the available texture (R₃), both representations being defined over a number of pixels in the image, and yielding as an output the degree of match value (μₘ).

5. An image encoder according to claim 1 wherein the comparator (40) is arranged to apply as the pre-determined matching criterion, a statistical matching function (44) taking as input, a statistical property (P₃′) of the representation of the generated texture (R₃′) and a statistical property (P₃) of the representation of the available texture (R₃) and yielding as an output the degree of match value (μₘ).

6. An image encoder according to claim 1 wherein the comparator (40) is arranged to apply as the pre-determined matching criterion, a distance measure function (45) taking as input, the third texture representing parameter (ρ₃ₑ) and the texture representing parameter (ρ₃ₒ) of the texture present in the third textured region of the input image and yielding as an output the degree of match value (μₘ).

7. An image encoder according to claim 1 wherein the encoder is arranged to encode video information comprising a temporal sequence (50) of images.

8. An image encoder according claim 1 wherein the image encoder is arranged to compress a first image (51) comprising the first textured region (54), a second image (52) comprising the second textured region (55) and a third image (53) comprising the third textured region (56) wherein the first image (51) and the second image (52) are temporally adjacent to the third image (53).

9. A method of encoding (60) an image (10), or a sequence of images, comprising at least one of a first textured region (11, 54) and a second textured region (12, 55), and a third textured region (13, 56), the method of encoding (60) comprising:
estimating (61) a third texture representing parameter (ρ₃ₑ) from at least one of a first texture representing parameter (ρ₁ₒ) of the first textured region (11) and a second texture representing parameter (ρ₂ₒ) of the second textured region (12) according to a predetermined estimating algorithm (K);
comparing (62) a representation (R₃′) of a generated texture corresponding to the estimated third texture representing parameter (ρ₃ₑ) with a representation (R₃) of a texture present in the third textured region (13) of the input image, according to a pre-determined matching criterion and calculating a degree of match value (μₘ); and
encoding (63) at least one of the first texture representing parameter and the second texture representing parameter (ρ₁ₒ,ρ₂ₒ) into a compressed data stream and encoding the texture present in the third textured region of the input image, or sequence of images, with a codification of the estimating algorithm (K) in the compressed data stream (67) when the degree of match value (μₘ) is within a pre-specified interval.

10. An image decoder (70) for decoding a compressed data stream ST(ρ₁ₒ,ρ₂ₒ, . . . ) comprising a codification of an estimating algorithm (K) into an image or sequence of images comprising at least one of a first textured region, a second textured region and a third textured region, the image decoder (70) comprising:
a data decoder (71) arranged to decode at least one of a first texture representing parameter (ρ₁ₒ) of the first textured region and a second texture representing parameter (ρ₂ₒ) of the second textured region from the compressed data stream ST(ρ₁ₒ,ρ₂ₒ, . . . );
a detector (72) for detecting the codification of the estimating algorithm (K) from the compressed data stream ST(ρ₁ₒ,ρ₂ₒ, . . . );
an estimator (73) for estimating a third texture representing parameter (ρ₃ₑ) of the third textured region from at least one of the first texture representing parameter (ρ₁ₒ) and the second texture representing parameter (ρ₂ₒ) according to a predetermined estimating algorithm as indicated by the estimating algorithm (K).

11. A method of decoding (80) a compressed data stream ST(ρ₁ₒ,ρ₂ₒ, . . . ) comprising a codification of an estimating algorithm (K) into an image or sequence of images comprising at least one of a first textured region, a second textured region and a third textured region, the method comprising:
decoding (81) a first texture representing parameter (ρ₁ₒ) of a first textured region, a second texture representing parameters (ρ₂ₒ) of a second texture region from the compressed data stream ST(ρ₁ₒ,ρ₂ₒ, . . . );
detecting (82) the codification of the estimating algorithm (K) from the compressed data stream ST(ρ₁ₒ,ρ₂ₒ,K);
estimating (83) a third texture parameter (ρ₃ₑ) from at least one of the first texture representing parameter (ρ₁ₒ) of the first textured region and the second texture representing parameter (ρ₂ₒ) of the second textured region according to a predetermined estimating algorithm as indicated by the estimating algorithm (K).

12. An image encoder (90) for compressing at least one image (94) or a sequence of images comprising textured regions into a compressed data stream (99), the image encoder comprising:
a first part (91) of the encoder arranged to encode the at least one image (96) comprising at least one image object into a first part of a compressed data stream (98A) conforming to a predefined image compression standard; and
a second part (93) of the encoder arranged to encode the textured regions (97B) into a second compressed data stream according to claim 1,
wherein the first (98A) and second (98B) compressed data streams are interleaved to represent a combined data stream (99) conforming to the predefined image compression standard.

13. A transmitter (100) for transmitting a compressed data stream (108) obtained by encoding at least one input image (104) or a sequence of images comprising textured regions, the transmitter (100) comprising:
a texture modeling unit (101) arranged to model a texture of a textured region, by means of a pre-defined model such as a two dimensional auto-regressive model, estimate a texture representing parameter (105) of the model and encode information of the model into a compressed data stream (106);
an image encoder (102) as claimed in claim 1, arranged to receive the texture representing parameter (105), and the representation of at least one texture available in the image (104) or sequence of images, and arranged to encode the texture representing parameter (105) and the codification of estimating algorithm further into the compressed data stream (107); and
a transmission unit (103), arranged to transmit the compressed data stream (107) to a data transmission entity or a storage entity.

14. A portable device (110) comprising:
a camera (111) arranged to capture at least one image (115);
a transmitter (112) according to the claim 13 arranged to transmit an encoded version of the at least one image (114) to a data transmission entity or a storage entity.

15. An image decoder (120) for decoding a compressed data stream (125) into at least one image (130), the image decoder (120) comprising:
a first part of the decoder (121) arranged to decode a first part of the compressed data stream (126) conforming to a predefined image compression standard into at least an image object (128); and
a second part of the decoder (123) arranged to decode a second part of the compressed data stream (127) comprising a codification of an estimating algorithm and parameters of textured regions as claimed in claim 10,
wherein the second part of the decoder (123) is further arranged to synthesize the textured regions (129) from the texture representing parameters and add the textured regions (129) to the image object to yield an output image (130).

16. A receiver (140) for receiving a compressed data stream (143) comprising an encoded version of at least one image from an image transmission (144) or storage utility (145), the receiver (140) comprising:
a decoder (141) arranged to decode the compressed data stream (143) into at least one output image (146) as claimed in claim 15;
an output means (142) arranged to connect the output image (146) to a comprised (143) or connectable (149) display.

17. A compressed encoded image signal comprising:
data encoding an image object present in an image on basis of a linear transformation of pixel values of groups of pixels comprised within an image object, according to a predefined image compression standard;
parametric data encoding a texture region comprised within the image; and
a codification of a model for generating further texture representing parameters on basis of the parametric data encoding the texture, usable for regenerating a further texture of the image.

18. A method of transmission of a compressed encoded image signal comprising a codification identifying a model for generating further texture representing parameters on basis of parametric data encoding a first textured region comprised within an image or sequence of images, usable for regenerating a further textured region comprised within the image or sequence of images, the method comprising:
encoding an image object present in the image on basis of a linear transformation of pixel values of groups of pixels comprised within the image object, into a compressed encoded image signal according to a predefined image compression standard;
encoding the first textured region comprised within the image by means of parametric data;
encoding codification of the model for generating further texture representing parameters on the basis of the parametric data, usable for regenerating the further texture of the image; and;
transmitting the encoded compressed data stream over the wired or wireless medium of data transmission.

19. A computer program product (150) to be loaded by a computer arrangement, comprising instructions for compressing an image or sequence of images comprising textured regions into a compressed data stream, the computer arrangement comprising processing unit and a memory, the computer program product, after being loaded, providing said processing unit with the capability to carry out the following tasks:
estimating a third texture representing parameter (ρ₃ₑ) from at least one of a first texture representing parameter (ρ₁ₒ) of the first textured region (11) and a second texture representing parameter (ρ₂ₒ) of the second textured region (12) according to a predetermined estimating algorithm (K);
comparing a representation (R₃′) of a generated texture corresponding to the estimated third texture representing parameter (ρ₃ₑ) with a representation (R₃) of a texture present in the third textured region (13), according to a pre-determined matching criterion and calculating a degree of match value (μₘ); and
encoding the first texture representing parameter (ρ₁ₒ) and the second texture representing parameter (ρ₂ₒ) into a compressed data stream ST(ρ₁ₒ,ρ₂ₒ, . . . ) and encoding the texture present in the third textured region with a codification of the estimating algorithm (K) in the compressed data stream ST(ρ₁ₒ,ρ₂ₒ,K) when the degree of match value (μₘ) is within a pre-specified interval.

20. An encoder according to claim 1 wherein the images are manually segmented to obtain textured regions.

21. An encoder according to claim 1 wherein the images are pre-segmented by means of an image segmentation algorithm to obtain textured regions and texture representing parameters.

22. An image encoder according to claim 7, wherein the estimator (21) is arranged to encode a difference texture for the time instant of the present time image, on the basis of the texture present in the third textured region (13) of the present time input image, and a texture motion-compensated to the third textured region (13) of the present time image, being generated from texture present in a comparable, and preferably time-inverse motion compensated region corresponding to the third textured region (13) of the present time image, textured region in at least one previous image, and wherein the data encoder (23) is arranged to encode the difference texture.
